(19) United States
(12) Patent Application Publication
(10) Pub. No.: US 2009/0295791 A1
(43) Pub. Date: Dec. 3, 2009

(54) THREE-DIMENSIONAL ENVIRONMENT CREATED FROM VIDEO

(75) Inventors: Blaise Aguera y Arcas, Seattle, WA (US); Brett D. Brewer, Sammamish, WA (US); Steven Drucker, Bellevue, WA (US); Karim Farouki, Seattle, WA (US); Gary W. Flake, Bellevue, WA (US); Stephen L. Lawler, Redmond, WA (US); Adam Sheppard, Seattle, WA (US); Richard Stephen Szeliski, Bellevue, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/129,247

(22) Filed: May 29, 2008

(51) Int. Cl. G06T 15/00

(52) U.S. Cl. 345/419

(57) ABSTRACT

The claimed subject matter provides a system and/or a method that facilitates constructing a three-dimensional (3D) virtual environment from two-dimensional (2D) content. A 3D virtual environment can enable a 3D exploration of a 3D image constructed from a collection of two or more 2D images, the 3D image is constructed by combining the two or more 2D images based upon a respective image perspective. The two or more 2D images can be provided by a video portion. An aggregator can reduce the number of frames in the video portion, construct a 3D image based upon key point features in the reduced number of frames and align the key point features geometrically in three dimensions.

### BACKGROUND

Advances in digital imaging technology have enabled people to easily and efficiently capture large collections of digital photographs and store them on compact storage media, hard drives or other devices. Typically, browsing the large collections of digital photographs involves presenting a slide show of images in the collections. In addition, browsing can involve displaying a large screen of low-resolution thumbnail images of the digital photographs. The thumbnail images enable a user to perceive a plurality of photographs simultaneously at the cost of image quality and detail.

Typical image browsing mechanisms do not convey real world relationships among photographs. For example, given a collection of photographs of a landscape or landmark, a user is not presented with information regarding how locations from which the photographs were taken relate to one another. Moreover, such mechanisms do not allow browsing between photographs or transitions between photographs based upon a real world relationship.

In addition to digital still photographs, conventional digital cameras enable users to shoot video of a scene. The videos are collected, browsed and organized separately from digital photographs even when the photographs are of the same scene as the videos. Further, relationships between videos and photographs are not typically captured even when videos encompass photographic imagery.

### SUMMARY

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

The subject innovation relates to systems and/or methods that facilitate displaying two-dimensional imagery within a three-dimensional virtual environment. A content aggregator can collect and combine a plurality of two dimensional (2D) images or content to create a three dimensional (3D) image, wherein such 3D image can be explored (e.g., displaying each image and perspective point) in a virtual environment. The 2D images or content can be provided by video segments obtained from multiple sources. In order to employ video imagery to create the three dimensional image, the content aggregator can reduce the number of frames included in the video segments. A reduced set of video frames can be analyzed to ascertain key point features contained therein. The key point features can be utilized to generate a point cloud (e.g., a rough 3D image of an object presented in the 2D imagery) by aligning key point features geometrically in 3D space. Additional 2D imagery can be collected and projected onto the 3D image in accordance with perspective of the image and geometry of the 3D image.

In accordance with another aspect of the subject innovation, the content aggregator can extract metadata from the video segments. For instance, audio associated with the video segments can be extracted. The extracted metadata can be incorporated into the 3D virtual environment. When displaying a perspective (e.g. a 2D projection) of a 3D image in the 3D virtual environment, metadata associated with the perspective can be concurrently presented (e.g., audio commences to play, tags overlaid on projection, etc.).

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates a block diagram of an exemplary system that facilitates generating a three-dimensional virtual environment.

FIG. 2 illustrates a block diagram of an exemplary system that facilitates creating a three-dimensional virtual environment based in part on two-dimensional video content.

FIG. 3 illustrates a block diagram of an exemplary system that facilitates inserting metadata within a three-dimensional virtual environment.

FIG. 4 illustrates a block diagram of an exemplary system that facilitates generating a three-dimensional virtual environment from two-dimensional content from a video device.

FIG. 5 illustrates a block diagram of an exemplary system that facilitates utilizing a display technique and/or a browse technique in accordance with the subject innovation.

FIG. 6 illustrates a block diagram of an exemplary system that employs intelligence to facilitate automatically creating a three-dimensional virtual environment from two-dimensional video content.

FIG. 7 illustrates an exemplary methodology for employing video content to generate a three-dimensional virtual environment.

FIG. 8 illustrates an exemplary methodology that facilities utilizing additional video metadata within a three-dimensional virtual environment generated from two-dimensional video content.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It can be evident, however, that the claimed subject matter can be practiced without these specific details. In other instances, well-known structures and devices are shown in block diagram form in order to facilitate describing the claimed subject matter.

As utilized herein, terms “component,” “system,” “data store,” “engine,” “generator,” “analyzer,” “aggregator,” “environment,” and the like are intended to refer to a computer-related entity, either hardware, software (e.g., in execution), and/or firmware. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

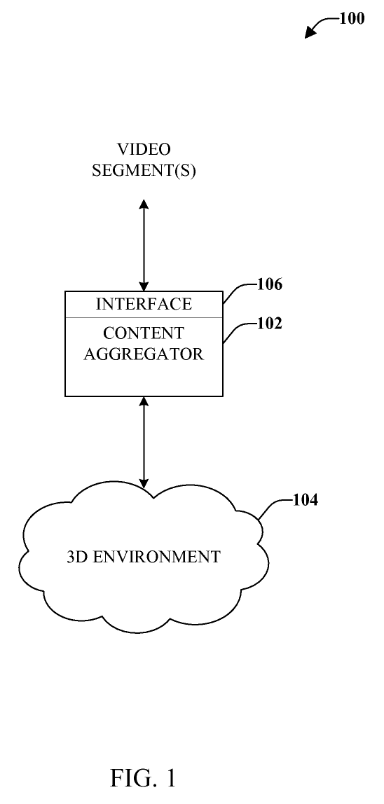

Now turning to the figures, FIG. 1 illustrates a system 100 that facilitates generating a three-dimensional virtual environment. The system 100 utilizes two-dimensional media content to derive the three-dimensional virtual environment. The system 100 can include a content aggregator 102 that can collect a plurality of two-dimensional (2D) content (e.g., media data, images, video, photographs, metadata, trade cards, etc) to create a three-dimensional (3D) virtual environment that can be explored (e.g., displaying each image and perspective point). For instance, the content aggregator 102 can aggregate a large collection of photos of a place or an object, analyze such photos for similarities, and display such photos in a reconstructed 3D space to create a virtualization of a 3D object. The display can depict how each photo relates geometrically in 3D space to other photos in the large collection. It is to be appreciated that the collected content can obtained from various locations (e.g., the Internet, local data, remote data, server, network, wirelessly collected data, etc.). Pursuant to an illustration, large collections of visual media content (e.g., gigabytes or more of content) can be accessed quickly (e.g., within seconds) in order to view a scene from virtually any angle or perspective. In other example, the content aggregator 102 can identify substantially similar content and zoom in to enlarge focus on small detail. In addition, the content aggregator 102 can zoom out to exhibit an image within a larger context of the virtualized 3D environment of the place or object. The content aggregator 102 can provide at least one of the following: 1) walk or fly through a scene to see content from various angles; 2) seamlessly zoom in or out of content independent of resolution (e.g., megapixels, gigapixels, etc.); 3) locate where content was captured in relation to other content; 4) locate similar content to currently view content; and 5) communicate a collection or particular view of content to an entity (e.g., user, machine, device, component, etc.).

Moreover, the system 100 can include a 3D environment 104 that can include a plurality of 2D images that include imagery related to a particular object (e.g., person, place, landscape, item, etc.). The images can each have a specific perspective of point of view. In particular, the 2D images can be aggregated or collected by the content aggregator 102 in order to construct a 3D image or object corresponding to the object represented in the imagery of the 2D images. The collection and/or aggregation can be based upon each 2D image perspective. The content aggregator 102 can construct the 2D images in order to provide a 3D image within the 3D environment 104 that can explored, navigated, browsed, etc.

Pursuant to an example, a 3D environment can be generated by the content aggregator 102 in which the 3D image can be a rectangular prism such as a simple cube. This cube can be created by combining a first image of a first face of the cube (e.g., the perspective is facing the first face of the cube), a second image of a second face of the cube (e.g., the perspective is facing the second face of the cube), a third image of a third face of the cube (e.g., the perspective is facing the third face of the cube), a fourth image of a fourth face of the cube (e.g., the perspective is facing the fourth face of the cube), a fifth image of a fifth face of the cube (e.g., the perspective is facing the fifth face of the cube), and a sixth image of a sixth face of the cube (e.g., the perspective is facing the sixth face of the cube). It is to be appreciated that images need not be restricted to the aforementioned perspectives. For example, a seventh image can be of a corner or other edge of the cube such that two or more faces of the cube are captured. The content aggregator 102 can aggregate the images of the cube faces based upon their perspective or point of views to geometrically align the images in 3D space. The aligned images constructs a 3D image of the cube within the 3D environment 106 that can be displayed, viewed, navigated, browsed and the like. For instance, the 3D environment can include a rough approximation of the 3D image of the cube. The 2D images can be projected onto the rough approximation when navigation or browsing to a location in the 3D environment corresponding to perspective, point of view and location of an originator of the 2D images.

It is to be appreciated that the 3D constructed object generated by the content aggregator 102 within the 3D environment 104 can be constructed from any suitable 2D content such as, but not limited to, images, photos, pictures, videos, etc. In accordance with an aspect, the content aggregator 102 can obtain one or more video segments to construct and/or supplement the 3D environment 106. The one or more video segments can include a video scene or portion thereof of a particular object (e.g., person, place, landscape, item, etc.) and can be collected from at least one video source (e.g., camera or other video device) or storage source (e.g., the Internet, locally retained data, remotely retained data, server, etc.). The content aggregator 102 can analyzes a plurality of frames from the one or more video segments to extract key features of the videoed object. The content aggregator 102 can utilize the key features and geometry therebetween to construct a point cloud. The point cloud can be a rough approximation of a 3D image or representation of the videoed object on which video frames and/or other images of the object can be projected or overlaid onto in accordance with the geometry of the key features.

Following the above example, the content aggregator 102 can collect a video segment of the cube. The video segment can be video that circles the cube or follows another motion relative to the cube. A subset of frames of the video segment can be employed by the content aggregator 102 to extract key features of the cube. The key features can be aligned geometrically in three dimensions to generate a point cloud of the cube. Frames of the video segment or other images of the cube can be obtained by the content aggregator 102 and projected onto the point cloud to provide a 3D environment of the cube that can be displayed, navigated, browsed and the like.

In addition, the system 100 can include any suitable and/or necessary interface component 106, which provides various adapters, connectors, channels, communication paths, etc. to integrate the content aggregator 102 into virtually any operating and/or database system(s) and/or with one another. In addition, the interface component can provide various adapters, connectors, channels, communication paths, etc., that provide for interaction with the content aggregator 102, the 3D environment 104, and any other device and/or component associated with the system 100.

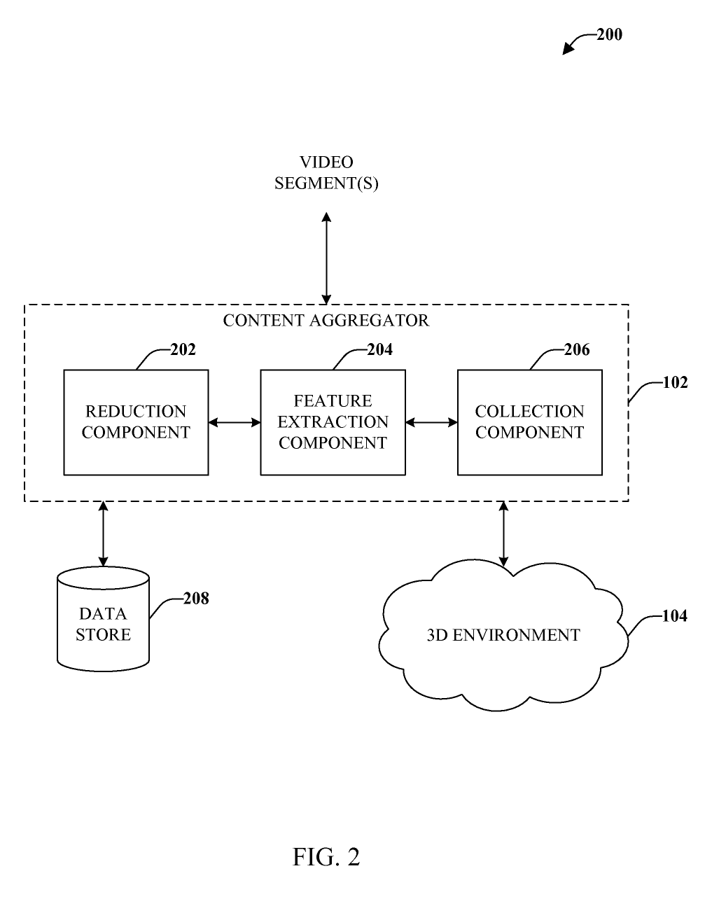

FIG. 2 illustrates a system 200 that facilitates creating a three-dimensional virtual environment based in part on two-dimensional video content. The system 200 can include a content aggregator 102 that generates a 3D environment 104 that can host a 3D object or images composed of a collection of two or more portions of 2D content. The 3D object or image can be created from the collection of two more portions of 2D content (e.g. images, video, photographs, etc.) based upon their perspectives, points of views, location (e.g. GPS) and the like. Pursuant to an illustrative embodiment, the content aggregator 102 can employ video segments to generate the 3D environment. In addition, the content aggregator 102 can utilize video segments to supplement or further define a previously constructed 3D environment.

Video segments can include numerous video frames that can number in the hundreds or thousands depending on length of the segment. For instance, film can have 24 frames each second, television video can have approximately 30 frames per second and some equipment can capture hundreds of frames per second. Each individual frame is a single still image and rapid succession of frames enables subtle motion to be perceived. However, the plurality of frames in a single second are typically very similar in terms of the images captured. Accordingly, the content aggregator 102, utilizing the entire video segment to generate the 3D environment 104, would redundantly process substantially similar images.

The content aggregator 102 can include a reduction component 202 that sparsifies or reduces the number of frames in video segments. The reduction component 202 can produce a reduced set of frames from the video segments that includes a subset of all frames from the video segments. For instance, the reduction component 202 can extract key frames from the video segments. Key frames include frames that designate a start point and/or an end point of a smooth transition in the video segments. In other words, key frames can define motion that is perceived by viewers. The reduction component 202 can retain only key frames (e.g. starting points and/or ending points) and disregard other frames of the smooth transition that can only vary slightly in content. It is to be appreciated that the reduction component 202 can employ other techniques to output the reduced set of frame beyond key frame extraction. For example, the reduction component 202 can take every xth frame where x is an integer greater than or equal to one. In addition, the reduction component 202 can periodically extract a frame from the video segments where the period can be a half second, a second, etc. Moreover, the reduction component 202 can employ image-processing techniques. Pursuant to an illustration, the reduction component 202 can analyze successive frames to determine differences therebetween. For instance, the reduction component 202 can determine a level of differences in an image presented in one frame and an image presented in an adjacent frame (e.g. previous frame or next frame). The frame can be included in the reduced set of frames if the level of differences exceeds a threshold. The threshold can be selected to maximize imagery of the videoed object while minimizing redundant processing.

The content aggregator 102 can further include a feature extraction component 204 that evaluates the reduced set of frames generated by the reduction component 202. The feature extraction component 204 analyzes each frame in the reduced set to ascertain key points in the still image of the frame. Key points represent points in that still image (e.g. 2D image content) that correspond to or project 3D points of the videoed object. Once identified, the key points can be organized according to the 3D geometry of the videoed object. Once organized, the key points comprise a point cloud or rough approximation of a 3D image of the videoed object. In addition, the feature extraction component 204 can align the reduced set of frames based upon perspectives or points of views of the frames when projected onto the key points in 3D space.

In addition, the content aggregator 102 can include a collection component 206 that manages a collection of 2D content utilized within the 3D environment 104. The collection component 206 can obtain additional 2D content to supplement the 3D environment 104. For instance, the collection component 206 can peruse the Internet or other remote content repository for 2D content that includes imagery of the object in the 3D environment 104. The 2D content can be obtained and analyzed to determine key point features to allow the 2D content to be aligned within the 3D environment 104. In addition, the collection component 206 can gather 2D content from a local source (e.g., a digital camera, data store, etc.). Moreover, a user can supply 2D content to the collection component.

The system 200 can further include a data store 208 that can include any suitable data related to the content aggregator 102, the 3D environment 104, the reduction component 202, the feature extraction component 204, the collection component 206, etc. For example, the data store 204 can include, but not limited to including, video frame data, key point data, 2D content, 3D object data, user interface data, browsing data, navigation data, user preferences, user settings, configurations, transitions, 3D environment data, 3D construction data, mappings between 2D content and 3D object or image, etc.

It is to be appreciated that the data store 208 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 204 of the subject systems and methods is intended to comprise, without being limited to, these and any other suitable types of memory. In addition, it is to be appreciated that the data store 208 can be a server, a database, a hard drive, a pen drive, an external hard drive, a portable hard drive, and the like.

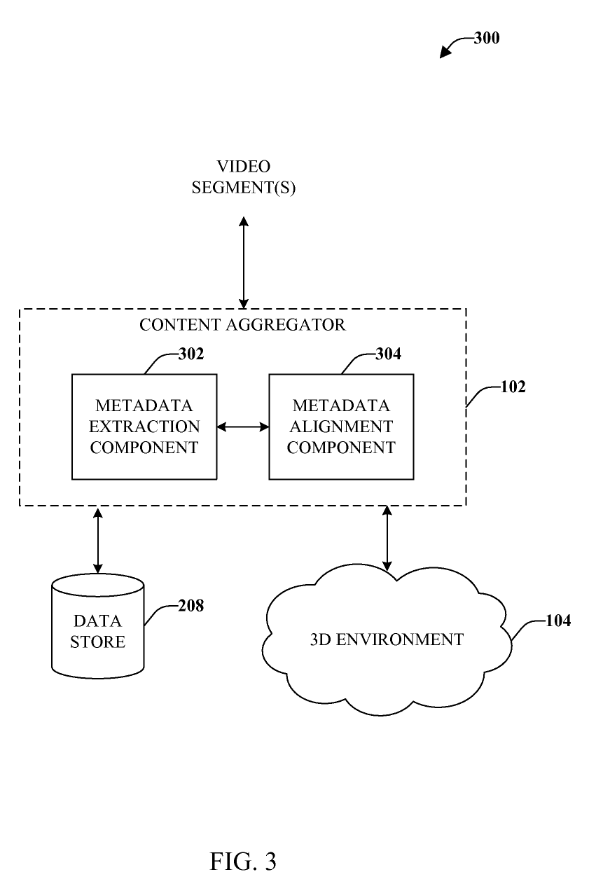

FIG. 3 illustrates a system 300 that facilitates inserting metadata within a three-dimensional virtual environment. The system 300 can include a content aggregator 102 that generates a 3D environment 104 that can host a 3D object or images composed of a collection of two or more portions of 2D content. The 3D object or image can be created from the collection of two more portions of 2D content (e.g. images, video, photographs, etc.) based upon their perspectives, points of views, location (e.g. GPS) and the like. Pursuant to an illustrative embodiment, the content aggregator 102 can employ video segments to generate the 3D environment. In addition, the content aggregator 102 can utilize video segments to supplement or further define a previously constructed 3D environment.

The content aggregator 102 can include a metadata extraction component 302 that can extract metadata associated with the video segments. The metadata can include data related to the content of the video segments, data related to the segments themselves or additional media embedded within the video segments (e.g., audio, etc.). For instance, the metadata can include data such as, but not limited to, an author, a device type, location (e.g. GPS), cardinality, audio, timestamps, watermarks, labels, tags, and the like. Pursuant to an illustration, a video segment can include metadata that specifies a person who shot the video, a device on which the video was shot, labels of objects in the video, tags of people in the video, a timestamp indicating time and date the video is produced, coordinates of the device during shooting, and/or audio received by an audio input device concurrently with the video. The metadata extraction component 302 can retain the metadata included in video segments utilized by the content aggregator 102 to generate to supplement the 3D environment 106.

The content aggregator 102 can further include a metadata alignment component 304 that merges extracted metadata with 2D content within the 3D environment 104. The metadata alignment component 304 can include data on a 2D image projected onto the 3D image (e.g. point cloud) within the 3D environment 104. For example, the metadata alignment component 304 can display a tag, label, or watermark on a 2D image that indicates the author, device, location, description of imagery, etc. The 2D image can be a video frame of the video segments (e.g., the source of the metadata) or the 2D image can be another image that presents similar imagery. Thus, metadata can be associated with additional content in the 3D environment and need not be restricted to content originally linked with the metadata.

Pursuant to an example, audio concurrently recorded with a video segment can be extracted by the metadata extraction component 302. The audio can be, for instance, a narrator describing a landmark being shot by a video device. The audio or a portion thereof can be included within the 3D environment 104 by the metadata alignment component 304. In an illustrative embodiment, the alignment enables the audio to play when a 2D projection of the 3D image of the landmark is displayed, navigated to or browsed to within the 3D environment 104.

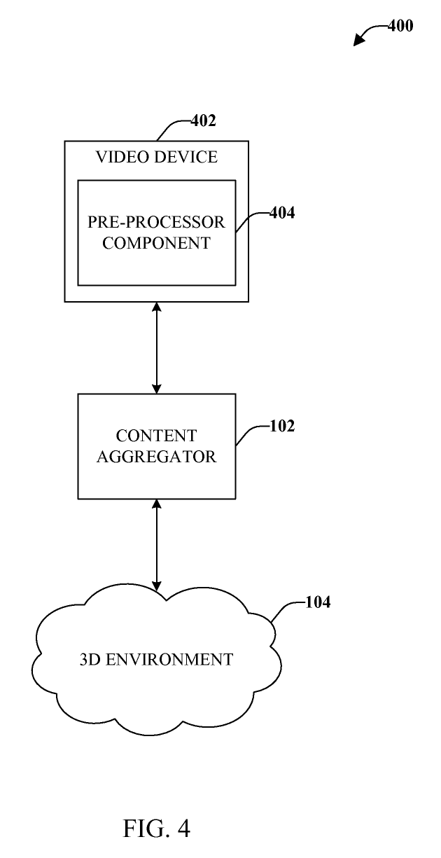

FIG. 4 illustrates a system 400 that facilitates generating a three-dimensional virtual environment from two-dimensional content from a video device. The system 400 can include a content aggregator 102 that generates a 3D environment 104 that can host a 3D object or images composed of a collection of two or more portions of 2D content. The 3D object or image can be created from the collection of two more portions of 2D content (e.g. images, video, photographs, etc.) based upon their perspectives, points of views, location (e.g. GPS) and the like. Pursuant to an illustrative embodiment, the content aggregator 102 can employ video segments to generate the 3D environment. In addition, the content aggregator 102 can utilize video segments to supplement or further define a previously constructed 3D environment.

Moreover, the system 400 includes a video device 402 that can acquire, produce or generate video segments. For instance, the video device 402 can be a digital video camera, a film video camera or any other video capture device. The video device 402 can be employed to shot a video segment of an object (e.g., person, place, landscape, item, etc.). The content aggregator 102 can utilize the video segment to construct a 3D image of the object within the 3D environment 104. The video device 402 can embed metadata into the video segment such as data described supra with reference to FIG. 3.

According to an aspect, the video device 402 can configured to facilitate construction of the 3D environment 104. The video device 402 can include a pre-processor component 404 that can process video segments prior to communication to the content aggregator 102. The pre-processor component 404 can reduce video frames, identify key points or perform any other processing related to generating, maintaining or supplementing the 3D environment 104 with video segment produced by the video device 402. For example, the video device 402 can be employed to shoot a video segment of a house. After shooting the video segment, the pre-processor component 404 can reduce the number of video frames and preliminarily identify key points in the video frames. It is to be appreciated that the pre-processor component 404 can operate in real-time while the video device 402 shoots the video segment. For instance, the video device 402 can be configured to operate in a mode to generate video or other 2D content suitable to construct the 3D environment 104. It is to be appreciated that the content aggregator 102 can process the video segments, the video device 402 can process the video segments or the content aggregator 102 and the video device 402 can partition processing the video segments. For example, the video device 402 can shoot a video of an object and provide a reduced video (e.g., remove unnecessary frames) to the content aggregator 102 for key point feature extraction. It is to be appreciated that other combination are possible.

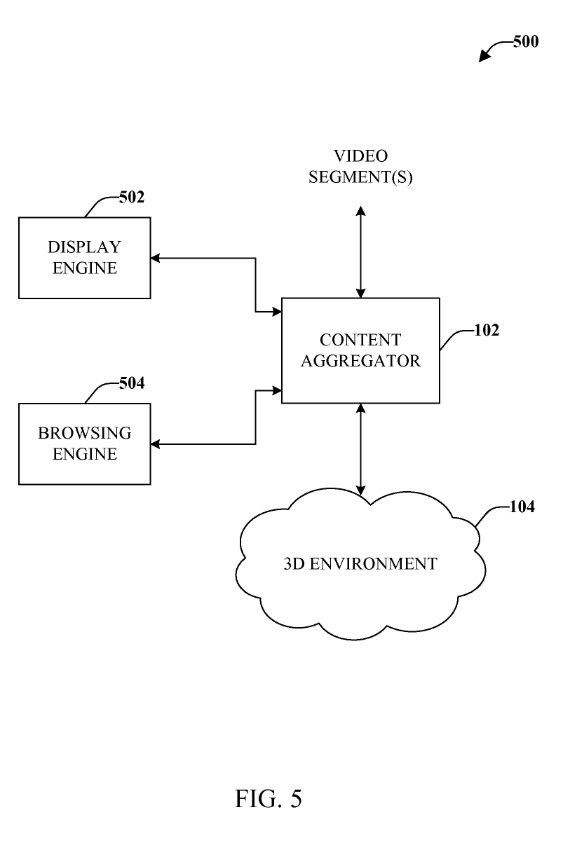

FIG. 5 illustrates a system 500 that facilitates utilizing a display technique and/or a browse technique in accordance with the subject innovation. The system 500 can include the content aggregator 102 and the 3D environment as described above. The system 500 can further include a display engine 502 enables seamless pan and/or zoom interaction with any suitable data (e.g., 3D object data, 2D imagery, content, etc.), wherein such data can include multiple scales or views and one or more resolutions associated therewith. In other words, the display engine 502 can manipulate an initial default view for displayed data by enabling zooming (e.g., zoom in, zoom out, etc.) and/or panning (e.g., pan up, pan down, pan right, pan left, etc.) in which such zoomed or panned views can include various resolution qualities. The display engine 502 enables visual information to be smoothly browsed regardless of the amount of data involved or bandwidth of a network. Moreover, the display engine 502 can be employed with any suitable display or screen (e.g., portable device, cellular device, monitor, plasma television, etc.). The display engine 502 can further provide at least one of the following benefits or enhancements: 1) speed of navigation can be independent of size or number of objects (e.g., data); 2) performance can depend on a ratio of bandwidth to pixels on a screen or display; 3) transitions between views can be smooth; and 4) scaling is near perfect and rapid for screens of any resolution.

For example, an image can be viewed at a default view with a specific resolution. Yet, the display engine 502 can allow the image to be zoomed and/or panned at multiple views or scales (in comparison to the default view) with various resolutions. Thus, a user can zoom in on a portion of the image to get a magnified view at an equal or higher resolution. By enabling the image to be zoomed and/or panned, the image can include virtually limitless space or volume that can be viewed or explored at various scales, levels, or views with each including one or more resolutions. In other words, an image can be viewed at a more granular level while maintaining resolution with smooth transitions independent of pan, zoom, etc. Moreover, a first view may not expose portions of information or data on the image until zoomed or panned upon with the display engine 502.

A browsing engine 504 can also be included with the system 500. The browsing engine 504 can leverage the display engine 502 to implement seamless and smooth panning and/or zooming for any suitable data browsed in connection with at least one of the Internet, a network, a server, a website, a web page, the 3D environment 104, and the like. It is to be appreciated that the browsing engine 504 can be a stand-alone component, incorporated into a browser, utilized with in combination with a browser (e.g., legacy browser via patch or firmware update, software, hardware, etc.), and/or any suitable combination thereof. For example, the browsing engine 504 can be incorporate Internet browsing capabilities such as seamless panning and/or zooming to an existing browser. For example, the browsing engine 504 can leverage the display engine 502 in order to provide enhanced browsing with seamless zoom and/or pan on a 3D object, wherein various scales or views can be exposed by smooth zooming and/or panning.

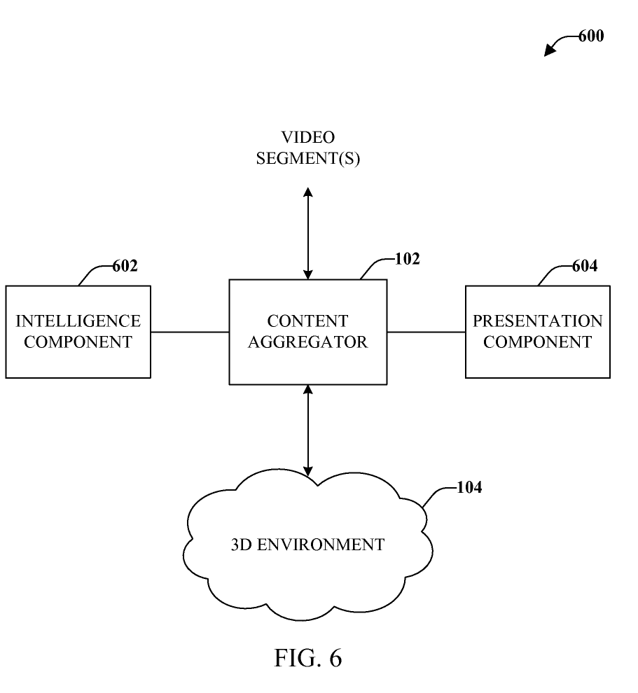

FIG. 6 illustrates a system 600 that employs intelligence to facilitate automatically creating a three-dimensional virtual environment from two-dimensional video content. The system 600 can include the content aggregator 102 and the 3D environment 104, which can be substantially similar to respective aggregators and environments described in previous figures. The system 600 can include an intelligence component 602. The intelligence component 602 can be utilizes by the content aggregator 102 to facilitate constructing 3D objects from 2D content (e.g. video segments). For example, the intelligence component 602 can infer key frames, key point features, combining imagery, aligning imagery, extrapolating geometric relationships, a graphical framework of a 3D object, media to project onto a 3D object, user preferences, setting, navigation or exploration preferences, etc.

The intelligence component 602 can employ value of information (VOI) computation in order to identify optimal frames or key point features to extract to construct the 3D environment 104. For instance, by utilizing VOI computation, the most ideal and/or appropriate frames of a video segment or key point features within a video frame can be determined. Moreover, it is to be understood that the intelligence component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The content aggregator 102 can further utilize a presentation component 604 that provides various types of user interfaces to facilitate interaction between a user and any component coupled to the content aggregator 102. As depicted, the presentation component 604 is a separate entity that can be utilized with the content aggregator 102. However, it is to be appreciated that the presentation component 604 and/or similar view components can be incorporated into the content aggregator 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the content aggregator 102.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

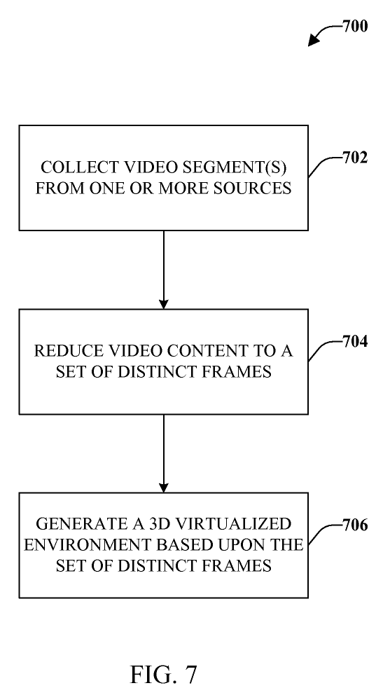

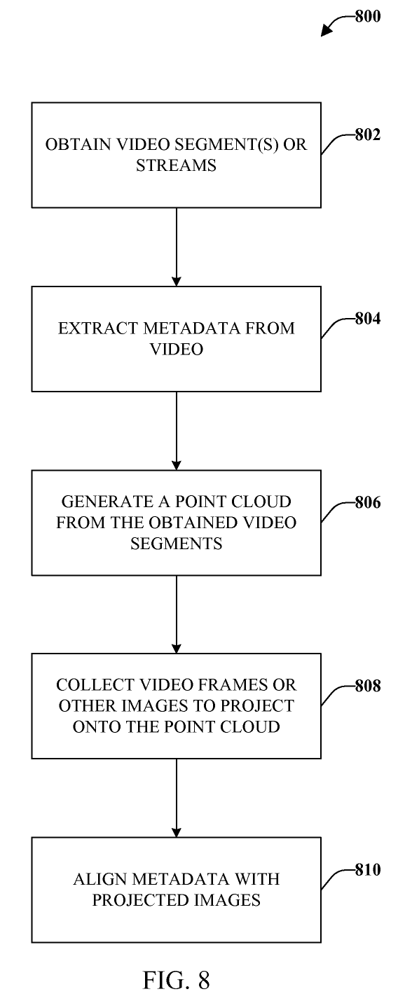

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example, acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 that facilities employing video content to generate a three-dimensional virtual environment. At reference numeral 702, video segments are collected from one or more sources. The one or more sources can include video devices, the Internet, local data, remote data, server, wireless captured data and the like. The video segments can include imagery related to a particular object (e.g. person, landscape, landmark, location, item, etc.). For instance, the video segments can include imagery of a pyramid (e.g. the Great Pyramids of Giza). The video segment can provide a video resulting from shooting the pyramid while circling around it (e.g., at its base, from a distance, from the air, etc.).

At reference numeral 704, the video content of the collected video segments is reduced to a set of distinct frames. Video segments can include numerous video frames that can number in the hundreds or thousands depending on length of the segment. Each individual frame is a single still image and rapid succession of frames enables subtle motion to be perceived. However, the plurality of frames in a single second are typically very similar in terms of the images captured. Thus, the video frames can be reduced to a set of frames that includes unique or distinct frames. It is to be appreciated that uniqueness or distinctiveness can be determined based upon perspective or point of view of the frame, zoom level of the frame, video effects applied to a frame, etc. The video segments can be reduced by selection only key frames, by selecting every xth frame (where x is an integer greater than or equal to one), by selecting a frame every time period (e.g., every half second, every second, etc.) and/or by applying image analysis techniques that evaluate level of differences between frames.

At reference numeral 706, a 3D virtualized environment is generated based upon the set of distinct video frames. The 3D virtualized environment can include a constructed 3D object based on the perspective and imagery of two or more 2D images from the set of distinct frames. In general, a 3D object or image can be created to enable exploration within a 3D virtual environment, wherein the 3D object or image is constructed from 2D content of the videoed object or image. The 2D imagery is combined in accordance with the perspective or point-of-view of the imagery to enable an assembled 3D object that can be navigated and viewed (e.g., the 3D object as a whole includes a plurality of 2D images or content). For example, 2D frames of the Great Pyramid can be employed to construct a 3D image representation of the Great Pyramid. The video frames can be projected on the 3D image representation in accordance with the 3D geometry. The video frames of the Great Pyramid can be aggregated to assemble a 3D object that can be navigated or browsed in a 3D virtual environment. It is to be appreciated that the aggregated or collected 2D content can be any suitable number of images or content.

FIG. 8 illustrates a method 800 that facilitates utilizing additional video metadata within a three-dimensional virtual environment generated from two-dimensional video content. At reference numeral 802, video segments or streams are obtained. The video segments can be video shot on a video device or video streams communicated in real-time. The video segments can include video imagery of a particular object (e.g. person, landscape, landmark, location, item, etc.) for which a 3D image representation within a 3D virtualized environment is desired. At reference numeral 804, metadata associated or embedded in the video segments or streams is extracted. The metadata can include data such as, but not limited to, an author, a device type, location (e.g. GPS), cardinality, audio, timestamps, watermarks, labels, tags, and the like.

At reference numeral 806, a point cloud is generated from the obtained video segments. The point cloud can be a rough approximation of a 3D image or representation of the videoed object on which video frames and/or other images of the object can be projected or overlaid onto in accordance with the geometry of the key features. Each video frame can be analyzed to ascertain key points in the still image representation of the frame. Key points represent points in the still image (e.g. 2D image content) that correspond to or project 3D points of the videoed object. Once identified, the key points can be organized according to the 3D geometry of the videoed object to produce the point cloud.

At reference numeral 808, video frame imagery or other 2D imagery is collected for projection onto the point cloud. The 2D imagery can be aligned based upon perspectives or points of views and when projected onto corresponding key points in 3D space. At reference numeral 810, extracted metadata is aligned with projected imagery. The extracted metadata is originally associated with video segments presenting 2D imagery of an object representing in the 3D space of the point cloud. The metadata can be embedded within projections on the point cloud that correspond to the original imagery.

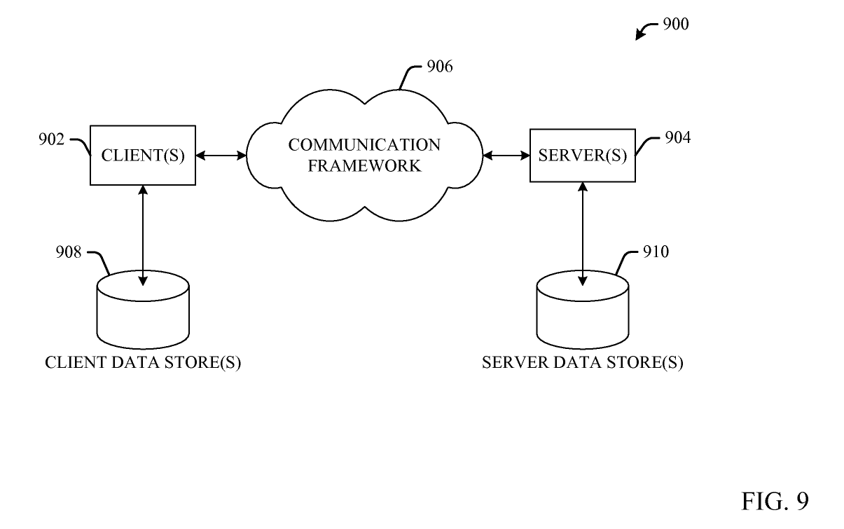

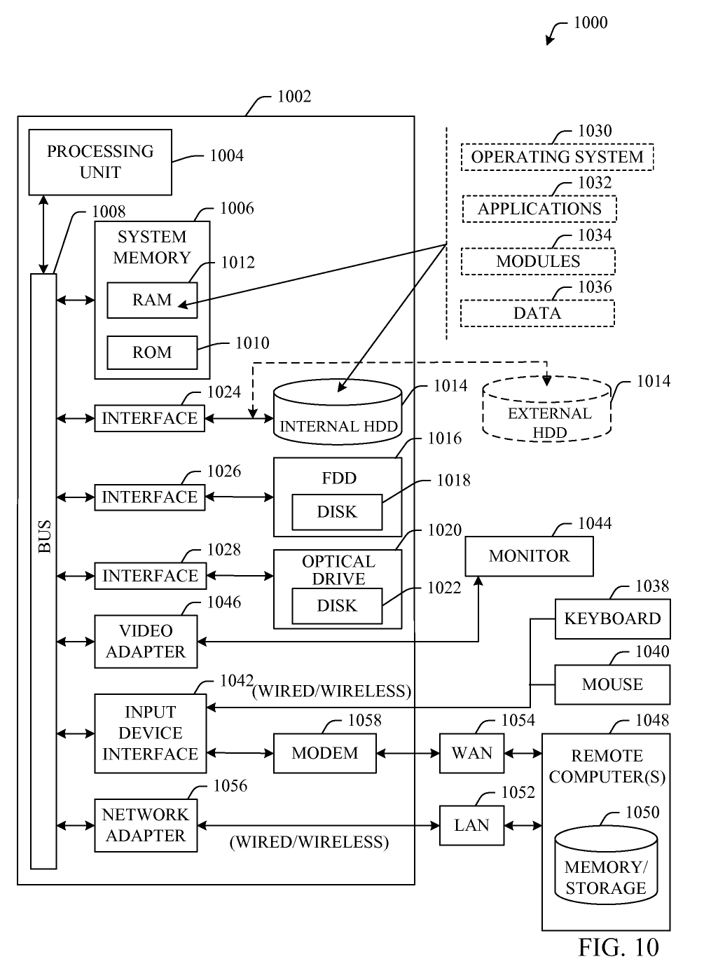

In order to provide a context for the various aspects of the disclosed subject matter, FIGS. 9 and 10 as well as the following discussion are intended to provide a brief, general description of a suitable environment in which the various aspects of the disclosed subject matter can be implemented. While the subject matter has been described above in the general context of computer-executable instructions of a program that runs on one or more computers, those skilled in the art will recognize that the subject matter described herein also can be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects can also be practiced in distributed computing environments where tasks are performed by remote processing devices that are linked through a communications network. However, some, if not all aspects of the claimed subject matter can be practiced on stand-alone computers. In a distributed computing environment, program modules can be located in both local and remote memory storage devices.

Referring now to FIG. 9, there is illustrated a schematic block diagram of a computing environment 900 in accordance with the subject specification. The system 900 includes one or more client(s) 902. The client(s) 902 can be hardware and/or software (e.g., threads, processes, computing devices). The client(s) 902 can house cookie(s) and/or associated contextual information by employing the specification, for example.

The system 900 also includes one or more server(s) 904. The server(s) 904 can also be hardware and/or software (e.g., threads, processes, computing devices). The servers 904 can house threads to perform transformations by employing the specification, for example. One possible communication between a client 902 and a server 904 can be in the form of a data packet adapted to be transmitted between two or more computer processes. The data packet can include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

Referring now to FIG. 10, there is illustrated a block diagram of a computer operable to execute the disclosed architecture. In order to provide additional context for various aspects of the subject specification, FIG. 10 and the following discussion are intended to provide a brief, general description of a suitable computing environment 1000 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the example environment 1000 for implementing various aspects of the specification includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the example operating environment, and further, that any such media can contain computer-executable instructions for performing the methods of the specification.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 is connected to the local network 1052 through a wired and/or wireless communication network interface or adapter 1056. The adapter 1056 can facilitate wired or wireless communication to the LAN 1052, which can also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates generation of a three-dimensional (3D) virtual environment, comprising:
an interface that obtains at least one video portion; and
a content aggregator that extrapolates a 3D virtual environment based at least in part on the at least one video portion, the 3D virtual environment enables a 3D exploration of a 3D image constructed from a collection of two or more two-dimensional (2D) images from the at least one video portion, the 3D image is constructed by combining the two or more 2D images based upon a respective image perspective.

2. The computer-implemented system of claim 1, the content aggregator further comprises a reduction component that reduces frames in the at least one video portion to a reduced set of frames, the two or more 2D images are drawn from the reduced set of frames.

3. The computer-implemented system of claim 2, the reduction component extracts key frames from the at least one video portion for inclusion in the reduced set of frames.

4. The computer-implemented system of claim 2, the reduction component selects every nth frame from the at least one video portion for inclusion in the reduced set of frames, n can be an integer greater than or equal to one.

5. The computer-implemented system of claim 2, the reduction component selects a frame every period for inclusion in the reduced set of frames, the period is measured in video time.

6. The computer-implemented system of claim 5, the period is one second.

7. The computer-implemented system of claim 2, the reduction component analyzes at least two frames to determine a level of difference between the at least two frames.

8. The computer-implemented system of claim 7, the reduction component includes the at least two frames when the level of difference exceeds a threshold.

9. The computer-implemented system of claim 1, the content aggregator further comprises a feature extraction component that analyzes a frame in the at least one video portion to ascertain key points in the frame image, key points represent points in the frame image that correspond to 3D points of an object filmed in the at least one video portion.

10. The computer-implemented system of claim 9, the feature extraction component aligns the key points based upon a 3D geometry of the object to construct a point cloud, the point cloud is a rough approximation of a 3D image of the object.

11. The computer-implemented system of claim 10, the content aggregator projects images from the reduced set of frames onto the point cloud, the images are projected such that key points in the images align with corresponding 3D points in the point cloud.

12. The computer-implemented system of claim 11, the content aggregator displays a projected image according to a perspective of a view of the 3D image of the object.

13. The computer-implemented system of claim 1, the content aggregator further comprises a collection component that manages a collection of 2D content utilized within the 3D environment, the collection of 2D content includes at least one of frames from the at least one video portion or additional 2D content related to an object represented within the 3D environment.

14. The computer-implemented system of claim 1, the content aggregator further comprises an extraction component that extracts metadata associated with the at least one video portion, the metadata can include at least one of data related to content of the at least one video portion, data related to the portion itself or additional media embedded within the video portion.

15. The computer-implemented system of claim 14, the content aggregator further comprises a metadata alignment component that merges extracted metadata with the two or more 2D images within the 3D environment.

16. The computer-implemented system of claim 1, further comprising a video device that produces the at least one video portion, the video device include a pre-processor component that performs at least one of a reduction of frames in the at least on video portion or an identification of key points within frames of the at least one video portion.

17. A computer-implemented method that facilitates generating a 3D virtual environment, comprising:
collecting at least one video portion;
eliminating frames of the at least one video portion to produce a reduced set of frames;
extracting key point features from the reduce set of frames;
aligning extracted key point features geometrically in three; and
projecting 2D images onto the key point features in accordance with the 3D geometric alignment.

18. The computer-implemented method of claim 17, further comprising:
extracting metadata from the at least one video portion; and
aligning the metadata with projected images.

19. The computer-implemented method of claim 17, further comprising collecting additional 2D images that relate to an object filmed in the at least one video portion, the additional 2D images are projected onto the key point features.

20. A computer-implemented system that facilitates creating a three-dimensional environment from two-dimensional content, comprising:
means for receiving a video segment that films an object;
means for decreasing frames of the video segment to a reduced set of frames;
means for extracting metadata associated with frames in the reduced set of frames;
means for identifying key point features from each frame within the reduced set of frames;
means for aligning identified key points features to generate a point cloud based upon a three dimensional geometry of the object;
means for constructing a 3D image of the object from a collection of two or more 2D images by projecting the two or more 2D images onto the point cloud based upon respective image perspective;
means for enabling a three dimensional exploration of the 3D image; and
means for displaying extracted metadata concurrently with projected 2D images, the projected 2D images selected based upon the three dimensional exploration.
